(19) United States
(12) Patent Application Publication
(10) Pub. No.: US 2026/0254137 A1
(43) Pub. Date: Aug. 27, 2026

(54) TERMINAL WITH COVER

(71) Applicant: SUMITOMO WIRING SYSTEMS, LTD., Mie (JP)

(72) Inventors: Atsushi SAKATANI, Mie (JP); Yuuichi IZAWA, Mie (JP)

(21) Appl. No.: 19/547,260

(22) Filed: Feb. 23, 2026

(30) Foreign Application Priority Data
Feb. 26, 2025 (JP) 2025-029027

(51) Int. Cl. H01R 4/70

(52) U.S. Cl. CPC H01R 4/70

(57) ABSTRACT

A terminal with a cover is a terminal with a cover including: a terminal cover; a wire W; a terminal; and a binding member, wherein the terminal has a fastening portion to be fastened to a device-side connection portion provided on a counterpart device, and a wire connection portion connected to the wire, the terminal cover has a terminal accommodation portion that accommodates the terminal, and a wire fixing portion that is continuous with the terminal accommodation portion and to which the wire is fixed by the binding member and from which the wire is drawn out, and the wire fixing portion is configured to suppress movement of the wire in a first direction in a view from a direction in which the wire is drawn out and to allow the wire to move in a second direction orthogonal to the first direction.

### CROSS-REFERENCE TO RELATED APPLICATIONS

This application is based on and claims priority from Japanese Patent Application No. 2025-029027, filed on Feb. 26, 2025, with the Japan Patent Office, the disclosure of which is incorporated herein in its entirety by reference.

### TECHNICAL FIELD

The present disclosure relates to a terminal with a cover.

### BACKGROUND

The terminal with a cover described in JP 2022-143048 A has been known conventionally. This terminal with a cover has a terminal cover that accommodates the terminal connected to an end of a wire. The terminal is connected to a counterpart device by fastening a bolt inserted into the terminal into a device-side connection portion provided on the counterpart device.

The terminal is constituted to include a bolt fastening portion bolted to the device-side connection portion of the counterpart device, a core wire connection portion that is provided at the bolt fastening portion via a linking portion and connected to the core wire of the wire, and a sheath connection portion connected to the sheath of the wire.

### SUMMARY

Although the bolt fastening portion, the core wire connection portion, and the sheath connection portion are arranged side by side on the same plane in the above terminal, depending on an environment in which the counterpart device is mounted, a terminal in which the bolt fastening portion and the core wire connection portion are connected through a bent portion may be adopted. A metal plate needs to be bent in order to form a bent portion, for example. However, there are cases where the bent portion cannot be formed at a desired angle due to influence of springback or the like, and the bolt fastening portion may become higher or lower than the original height. In addition, when crimping the core wire connection portion and the sheath connection portion, the height of the bolt fastening portion may also vary depending on crimping conditions.

In such a case, when the bolt fastening portion is bolted to the device-side connection portion of the counterpart device, the bolt fastening portion is fixed to correspond with the position of the device-side connection portion, which causes the entire terminal to tilt and the wire to also attempt to be displaced within the terminal cover in response to the tilt of the terminal. When the wire is a thick wire, the bending rigidity of the wire is high, and the terminal cover may deform by the reaction force of the wire.

The terminal with a cover according to the present disclosure is a terminal with a cover, including: a terminal cover; a wire; a terminal; and a binding member, wherein the terminal has a fastening portion to be fastened to a device-side connection portion provided on a counterpart device, and a wire connection portion connected to the wire, the terminal cover has a terminal accommodation portion that accommodates the terminal, and a wire fixing portion that is continuous with the terminal accommodation portion and to which the wire is fixed by the binding member and from which the wire is drawn out, and the wire fixing portion is configured to suppress movement of the wire in a first direction in a view from a direction in which the wire is drawn out and to allow the wire to move in a second direction orthogonal to the first direction.

According to the present disclosure, deformation of the terminal cover caused by the reaction force of the wire can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a terminal with a cover according to an embodiment, seen from a wire fixing portion side.

FIG. 2 is a perspective view of the terminal with a cover according to the embodiment, seen from a fastening portion side.

FIG. 3 is a right side view of the terminal with a cover according to the embodiment.

FIG. 4 is a left side view of the terminal with a cover according to the embodiment.

FIG. 5 is a plan view of the terminal with a cover according to the embodiment.

FIG. 6 is a bottom view of the terminal with a cover according to the embodiment.

FIG. 7 is a front view of the terminal with a cover according to the embodiment.

FIG. 8 is a perspective view of the terminal with a cover according to the embodiment in a state where a terminal cover is open.

FIG. 9 is an exploded perspective view of the terminal with a cover according to the embodiment in a state where the terminal cover is open.

FIG. 10 is a cross-sectional view taken along line A-A in FIG. 3.

FIG. 11 is a left side view showing how the fastening portion is displaced upward during fastening.

FIG. 12 is a left side view showing how the fastening portion is displaced downward during fastening.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments according to the present disclosure will be listed and described below.

[1] The terminal with a cover according to the present disclosure is a terminal with a cover, including: a terminal cover; a wire; a terminal; and a binding member, wherein the terminal has a fastening portion to be fastened to a device-side connection portion provided on a counterpart device, and a wire connection portion connected to the wire, the terminal cover has a terminal accommodation portion that accommodates the terminal, and a wire fixing portion that is continuous with the terminal accommodation portion and to which the wire is fixed by the binding member and from which the wire is drawn out, and the wire fixing portion is configured to suppress movement of the wire in a first direction in a view from a direction in which the wire is drawn out and to allow the wire to move in a second direction orthogonal to the first direction.

With such a configuration, the wire fixing portion can inhibit the wire from moving in the first direction while the wire fixing portion allows the wire to move in the second direction. Therefore, when the wire attempts to be displaced in the second direction, by allowing room for the wire to a movable region, it is possible to inhibit the terminal cover from deforming due to the reaction force of the wire.

In the terminal with a cover according to [1] above, it is preferable that the second direction is a direction in which the wire can move when the fastening portion is fastened to the device-side connection portion.

With such a configuration, when the wire moves in the second direction by fastening the fastening portion to the device-side connection portion, it is possible to allow room for the wire to the movable region.

[2] In the terminal with a cover according to [1] or [2] above, it is preferable that the second direction is a direction in which the wire can rotate around the fastening portion in a view from the first direction.

With such a configuration, when the wire rotates in the second direction around the fastening portion in a view from the first direction, it is possible to allow room for the wire to the movable region.

In the terminal with a cover according to any one of [1] to [3] above, it is preferable that the binding member is a cable tie, the wire fixing portion has a band insertion hole into which the cable tie is inserted, the cable tie has an insertion portion inserted into the band insertion hole, and a wire contact portion that is in contact with the wire, and the first direction is a direction from the wire contact portion toward the insertion portion.

With such a configuration, when the wire is fixed to the wire fixing portion by using a cable tie, the wire can be fixed in the first direction between the wire contact portion and the insertion portion of the cable tie.

In the terminal with a cover according to any one of [1] to [4] above, it is preferable that the terminal has a connector that connects the fastening portion and the wire connection portion, and the connector positions the wire connection portion at a predetermined angle with respect to the fastening portion.

With such a configuration, for example, even when the position of the fastening portion varies when the connector is subjected to bending processing, the wire can move in the second direction, thereby suppressing deformation of the terminal cover caused by the reaction force of the wire.

In the terminal with a cover according to any one of [1] to [5] above, it is preferable that the wire connection portion has a wire barrel to which a core wire of the wire is crimped.

With such a configuration, for example, even when the position of the fastening portion varies when the wire barrel is crimped, the wire can move in the second direction, thereby suppressing the deformation of the terminal cover.

### Details of Embodiments of the Present Disclosure

A specific example of the connector according to the present disclosure will be described with reference to the drawings. In each drawing, for convenience of description, portions of the configuration may be exaggerated or simplified. Also, the dimensional proportions of each portion may differ between drawings. Being “orthogonal” or “parallel” as used herein includes not only being strictly orthogonal or parallel, but also being generally orthogonal or parallel, as long as functional effects of an embodiment can be achieved. The term “tubular” used in the description of this specification includes not only those in which a circumferential wall is continuously formed throughout the entire circumference, but also includes those in which multiple components are combined to form a tubular shape, and those in which a portion in the circumference direction has a cutout or the like, such as a C-shape or U-shape. The “tubular” shapes include, but are not limited to, circular shapes, elliptical shapes, and polygons with sharp or round corners. The term “facing” in this specification also refers to surfaces or members being positioned in front of each other, and includes not only cases where they are positioned completely in front of each other, but also cases where they are positioned partially in front of each other. In addition, the term “opposing” in this specification includes a case where two members are separated from each other, and a case where two members are in contact with each other. In addition, the terms “first”, “second”, and “third” in t his specification are used merely to distinguish between objects and do not rank the objects. Note that the present invention is not limited to these examples, but is indicated by the claims and is intended to include all changes within the meaning and scope of the claims and equivalents.

### Embodiments

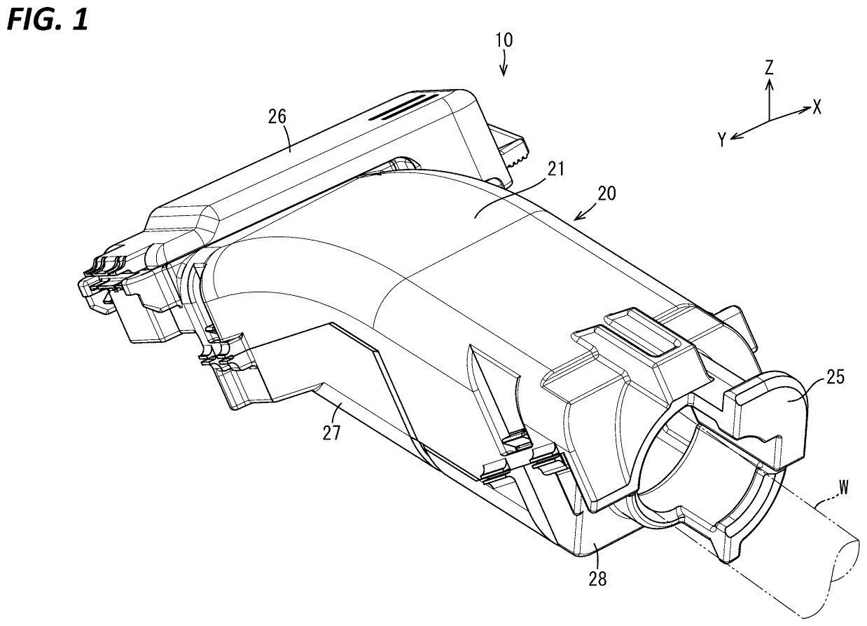

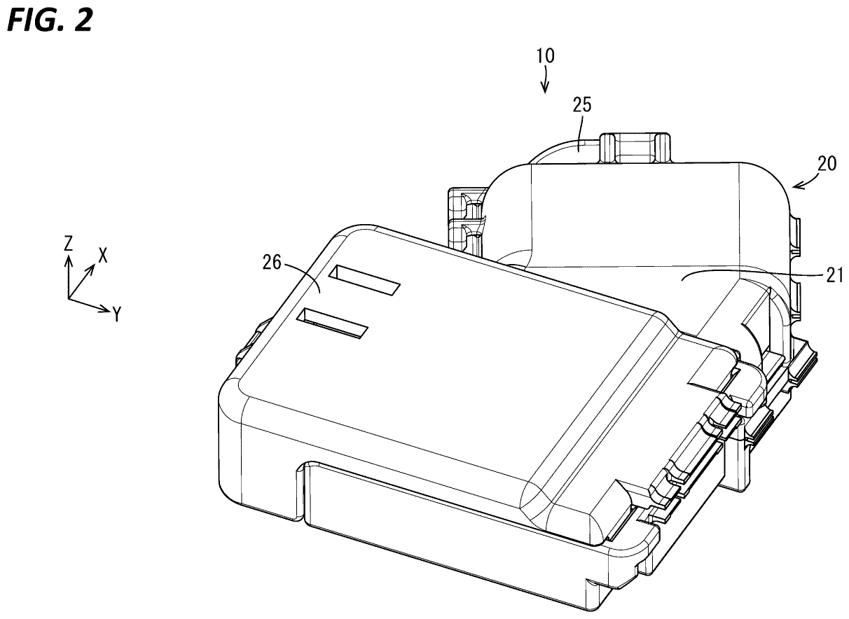

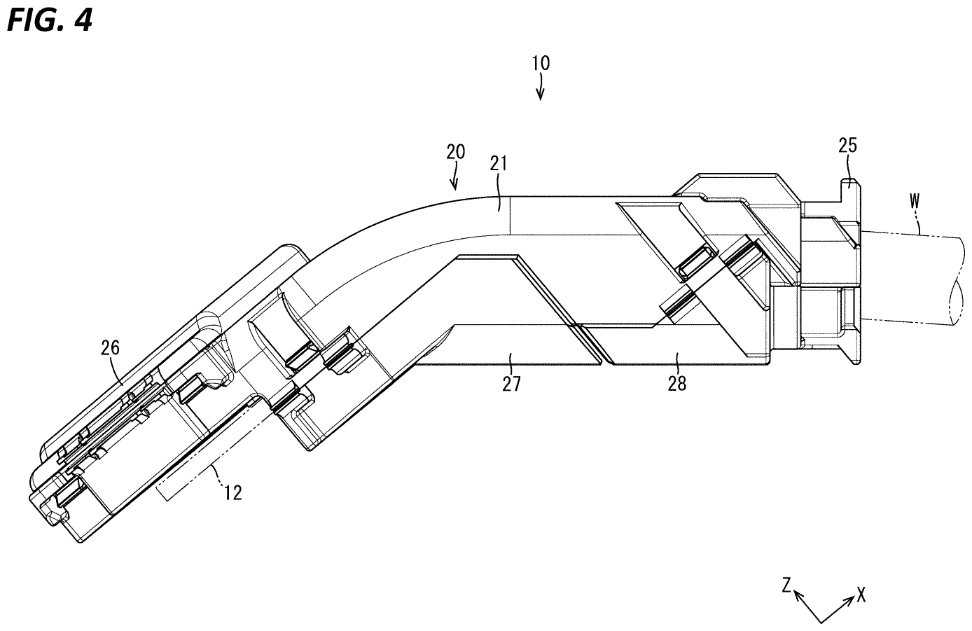

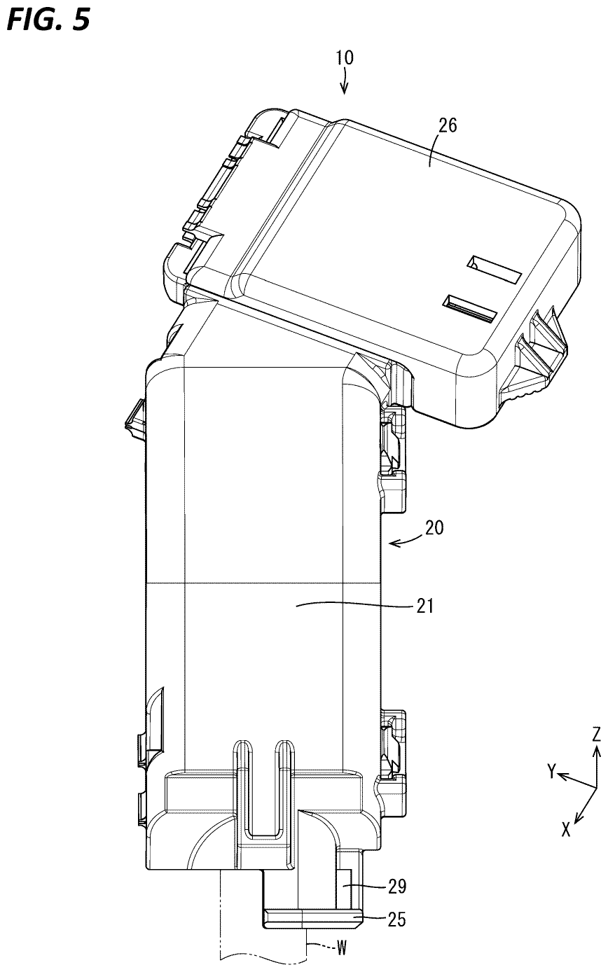

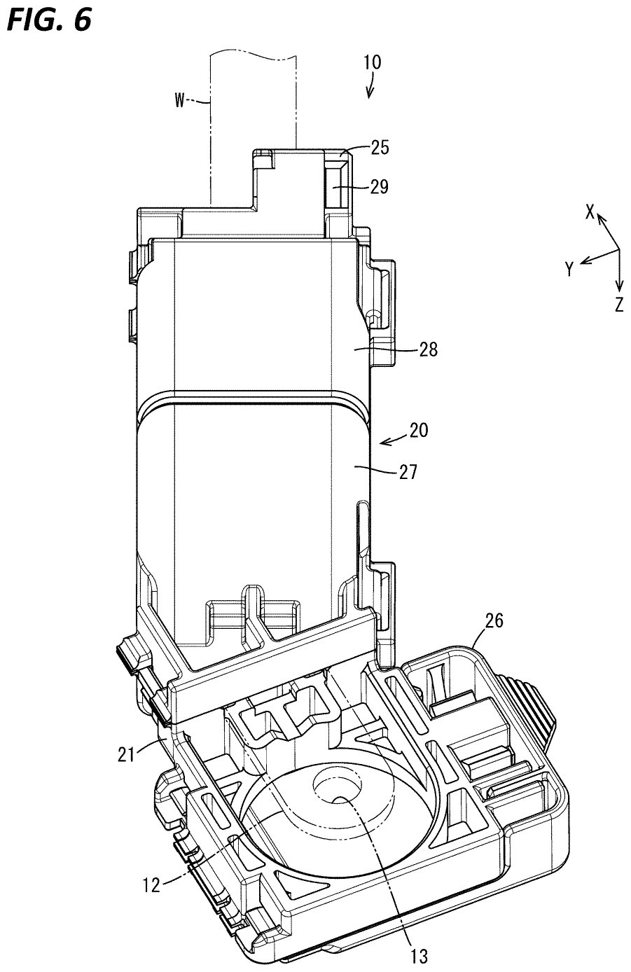

A terminal with a cover of an embodiment according to the present disclosure will be described with reference to FIGS. 1 to 12. In the following description, an X-axis direction is referred to as a front-rear direction, a Y-axis direction is referred to as a left-right direction, and a Z-axis direction is referred to as an up-down direction. In each drawing, the direction indicated by the arrow X is defined as a forward direction, the direction indicated by the arrow Y is defined as a left direction, and the direction indicated by the arrow Z is defined as an upper direction.

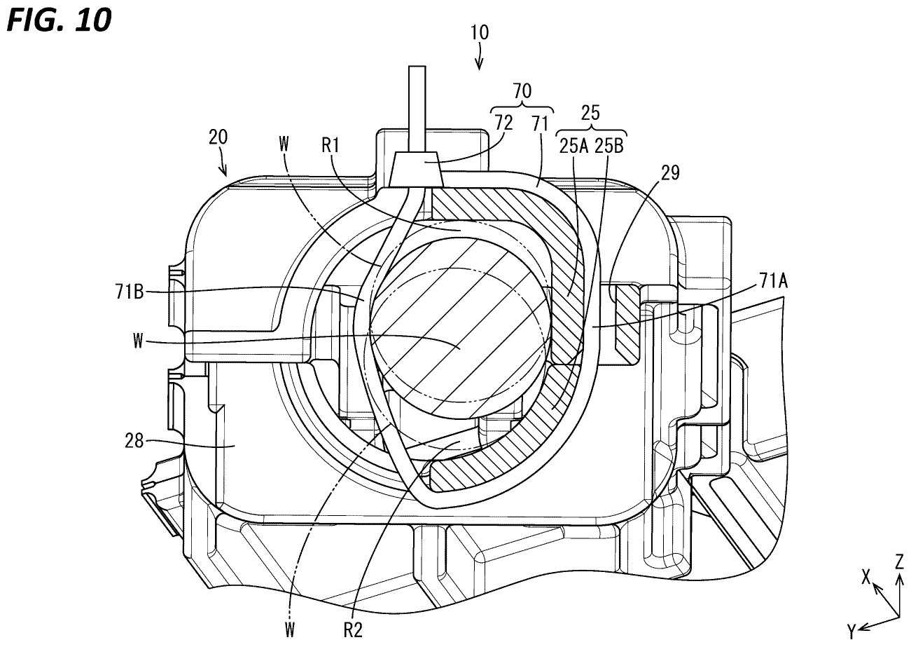

In this embodiment, the left-right direction shown in FIG. 10 in a view from a direction in which the wire is drawn out in FIG. 10 corresponds to the first direction in the present disclosure, and the up-down direction shown in FIG. 10 perpendicular to the left-right direction shown in FIG. 10 corresponds to the second direction in the present disclosure. In addition, the directions in the drawings do not necessarily represent the orientation of the terminal with a cover and the counterpart device (not shown) when the terminal with a cover is in use. Also, only some of a plurality of the same members may be given reference numerals, and other members may not be given reference numerals. (Overall Configuration of Terminal 10 with Cover)

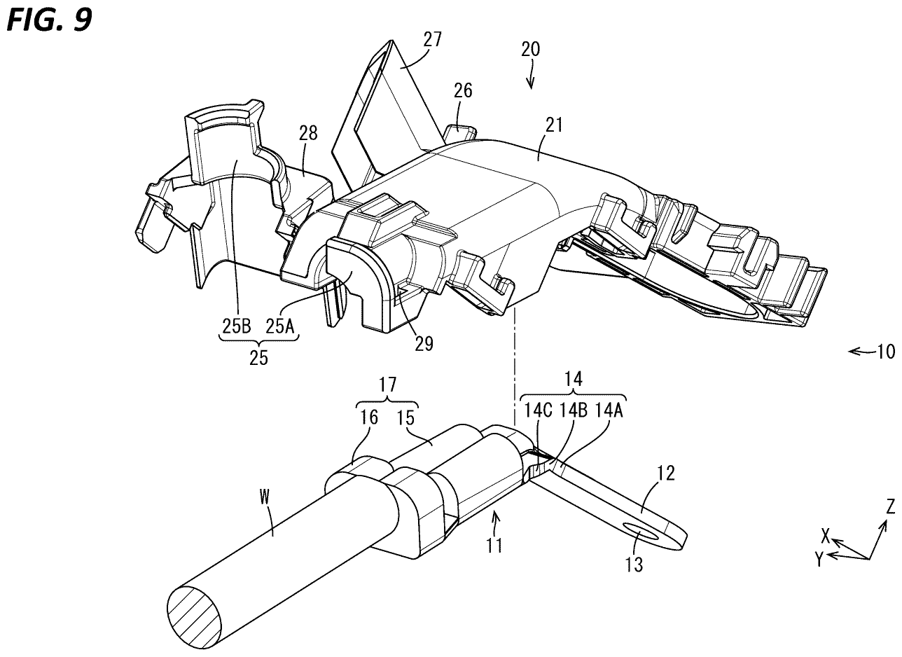

As shown in FIG. 9, a terminal 10 with a cover according to this embodiment has a terminal cover 20 that accommodates a terminal 11 connected to an end of a wire W. The terminal 11 is connected to a counterpart device by fastening, for example, a bolt or nut to a device-side connection portion provided on the counterpart device (not shown). The counterpart device here includes, for example, the body of a vehicle, the battery, and a terminal block provided on the device.

### Overall Configuration of Terminal 10 with Cover

As shown in FIGS. 1, 9, and 10, the terminal 10 with a cover according to this embodiment includes the wire W, the terminal cover 20, and the terminal 11. As will be described later, the wire W is fixed to the terminal cover 20 by a cable tie 70. The cable tie 70 is an example of the binding member according to the present disclosure.

One terminal 11 is provided on one terminal 10 with a cover. As shown in FIG. 9, the terminal 11 has a fastening portion 12 to be fastened to the device-side connection portion provided on the counterpart device, a wire connection portion 17 connected to the wire, and a connector 14 that connects the fastening portion 12 to the wire connection portion 17. The terminal 11 is formed by punching out a metal plate with excellent conductivity by pressing and then bending it.

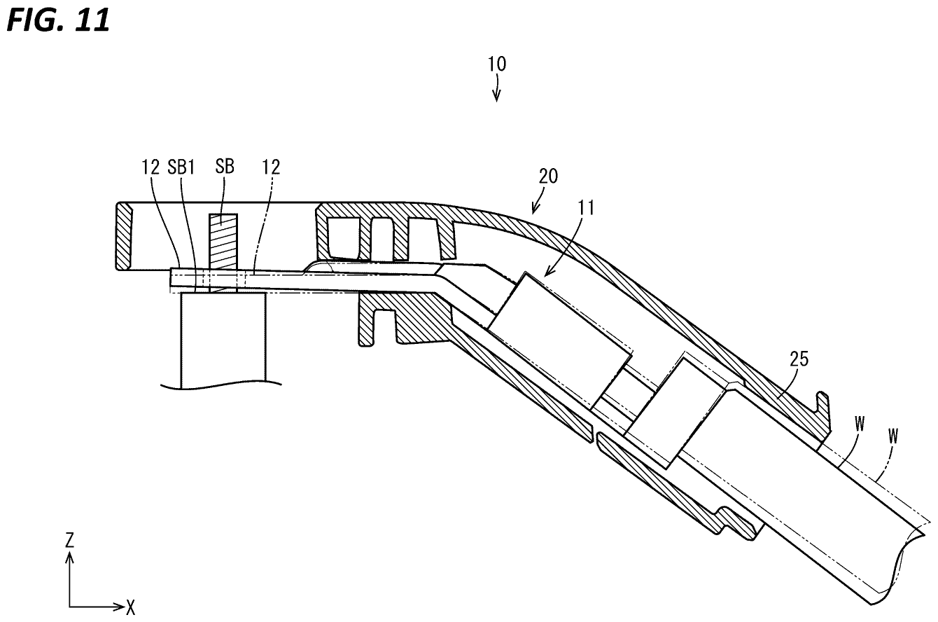

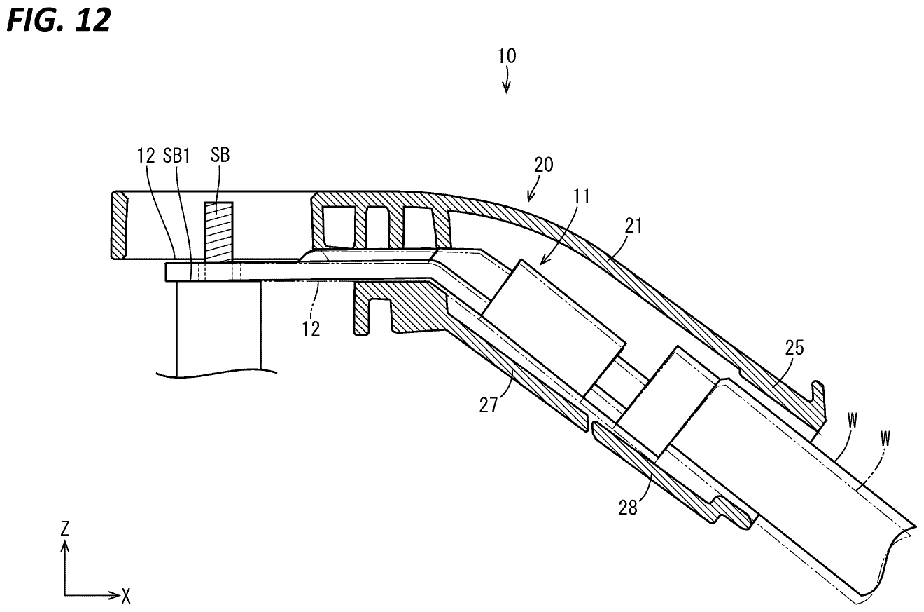

The fastening portion 12 is substantially oval plate-shaped, and has a fastening hole 13 that allows a bolt such as stud bolt SB to be inserted when the fastening portion 12 is fastened to the device-side connection portion. On the other hand, as an example of the device-side connection portion, the stud bolt SB is provided in the counterpart device, as shown in FIGS. 11 and 12. The fastening portion 12 has a dimension slightly larger than a seat SB1 of the stud bolt SB. When the nut (not shown) is tightened onto the stud bolt SB, the fastening portion 12 is clamped between the seat SB1 of the stud bolt SB and the nut, and the fastening portion 12 and the device-side connection portion are connected to each other to be capable of electrical conduction.

The connector 14 has a first connector 14A positioned to be continuous with the fastening portion 12, a second connector 14C positioned to be continuous with the wire connection portion 17, and a bent portion 14B arranged between the first connector 14A and the second connector 14C. The wire connection portion 17 and the fastening portion 12 can be disposed at a predetermined angle depending on the bending angle of the bent portion 14B. In this embodiment, the wire connection portion 17 is disposed at an angle of approximately 20 degrees relative to the fastening portion 12.

As shown in FIG. 9, the wire W is connected to the wire connection portion 17. The wire W is a well-known covered wire having a conductive core wire and an insulating sheath that covers the outer circumferential surface of the core wire. The wire connection portion 17 has a wire barrel 15 connected to the core wire of the wire W and an insulation barrel 16 connected to the insulating sheath. The wire barrel 15 is connected to the core wire of the wire W by, for example, crimping or ultrasonic welding.

### Terminal Cover 20

The terminal cover 20 is constituted to include a terminal accommodation portion 21 that accommodates the terminal 11 in a portion where members from the fastening portion 12 to the insulation barrel 16 of the terminal 11 are disposed, and the wire fixing portion 25 to which the wire W is fixed by a cable tie 70 and from which the wire W is drawn out and that is continuous with the terminal accommodation portion 21 in the direction in which the wire is drawn out, and a plurality of lids 26, 27, and 28. The terminal cover 20 is made of an insulating synthetic resin material. The plurality of lids 26, 27, and 28 are connected to the terminal accommodation portion 21 via hinges.

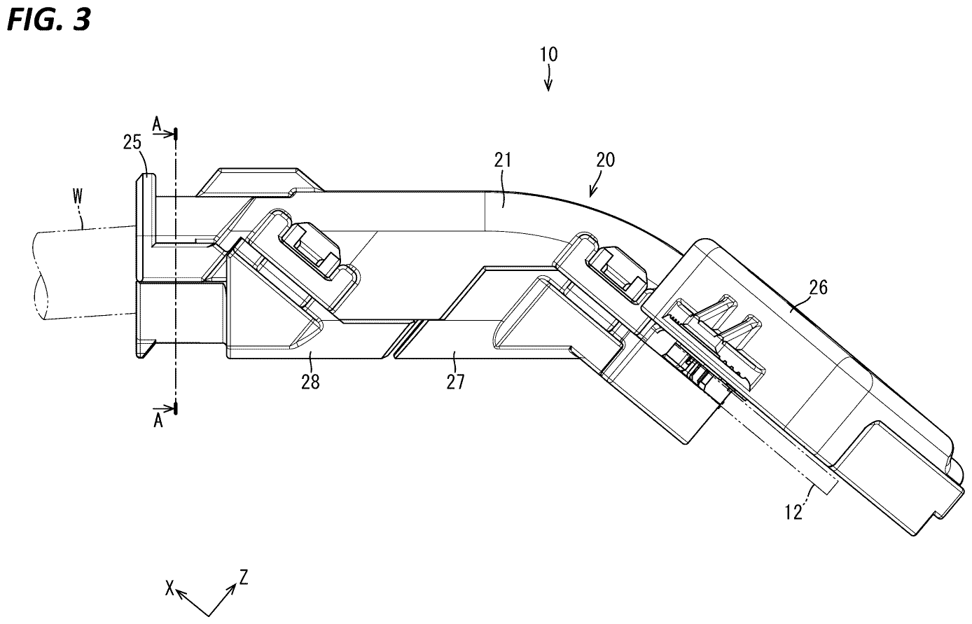

As shown in FIGS. 3 to 9, the lid 26 is arranged to correspond to the fastening portion 12, and the lid 27 is arranged to correspond to the connector 14, the wire barrel 15, and the insulation barrel 16, and the lid 28 is arranged to correspond to the wire W drawn out from the terminal 11.

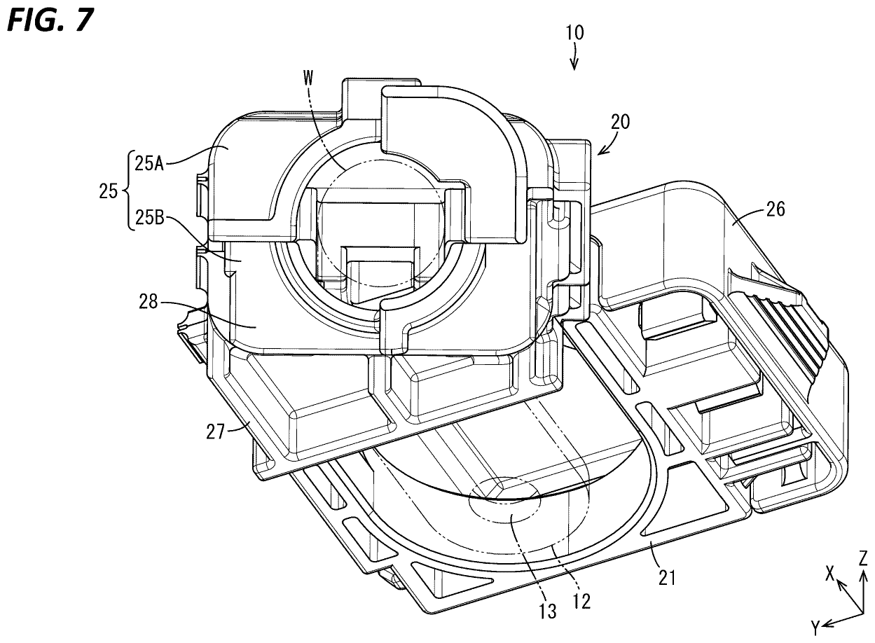

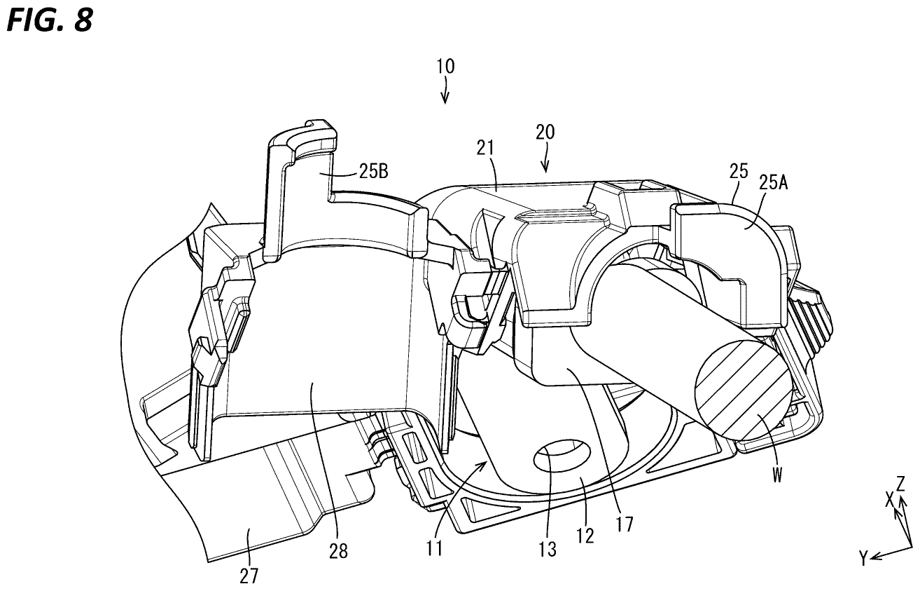

As shown in FIGS. 7 and 8, the wire fixing portion 25 has an upper fixing portion 25A formed on the terminal accommodation portion 21 side and a lower fixing portion 25B formed on the lid 28 side. The upper fixing portion 25A has a band insertion hole 29 into which the cable tie 70 is inserted. As shown in FIGS. 9 and 10, the band insertion hole 29 is formed at an outer peripheral end of the upper fixing portion 25A at a position where the band insertion hole 29 faces the lower fixing portion 25B.

### Cable Tie 70

As shown in FIG. 10, the cable tie 70 has a band 71 and a band fixing portion 72, which fixes the band 71. The band 71 is wrapped around the right half of the upper fixing portion 25A and the right half of the lower fixing portion 25B, shown in FIG. 10. The wire W is wrapped using the band 71 together with the upper fixing portion 25A and the lower fixing portion 25B. The band 71 is fixed by the band fixing portion 72, and thus the wire W is fixed to the wire fixing portion 25.

The band 71 has an insertion portion 71A inserted into the band insertion hole, and a wire contact portion 71B that is in contact with the wire W. When the wire W is bound by the cable tie 70, the wire W is pulled toward the insertion portion 71A (in the first direction) by the wire contact portion 71B. When the wire W comes into contact with an inner surface of the wire fixing portion 25, the pulling of the wire W stops, and the wire W is clamped in the first direction between the wire contact portion 71B of the band 71 and the inner surface of the wire fixing portion 25. As a result, the wire W is fixed so as not to move in the first direction in a view from the direction in which the wire W is drawn out.

The wire W indicated by solid lines in FIGS. 11 and 12 shows the case where the fastening portion 12 is not bent up or bent down during a process for manufacturing the terminal 11. The wire W indicated by the dashed double-dotted line in FIG. 11 shows the case where the fastening portion 12 has been bent up, and the wire W indicated by the dashed double-dotted line in FIG. 12 shows the case where the fastening portion 12 has been bent down. The process for manufacturing the terminal 11 may be, for example, a process for manufacturing the terminal 11, or may be, for example, a process for crimping the wire W.

As shown in FIG. 11, when the nut is fastened onto the stud bolt SB with the fastening portion 12 bent up, the fastening portion 12 is pushed downward toward the seat SB1, and as indicated by the dashed double-dotted line, the seat SB1 and the fastening portion 12 are positioned in horizontal orientation, thus completing the fastening of the nut. Accordingly, the terminal 11 rotates in the counterclockwise direction around the fastening portion 12, and thus the wire W connected to the wire connection portion 17 also rotates in the counterclockwise direction around the fastening portion 12. Then, the wire W attempts to move upward relative to the wire fixing portion 25.

As shown in FIG. 10, an upper movable region R1 is formed above the wire W indicated by the solid line. When the wire W attempts to move upward relative to the wire fixing portion 25, the wire W is allowed to move upward in the second direction toward the upper movable region R1. Therefore, even when the wire W comes into contact with the inner surface of the wire fixing portion 25 from below, the reaction force of the wire W is reduced and deformation of the terminal cover 20 is suppressed.

As shown in FIG. 12, when the nut is fastened onto the stud bolt SB with the fastening portion 12 bent down, the fastening portion 12 is pushed downward toward the seat SB1, and as indicated by the dashed double-dotted line, the seat SB1 and the fastening portion 12 are positioned in horizontal orientation, thus completing the fastening of the nut. Accordingly, the terminal 11 rotates in the clockwise direction around the fastening portion 12, and thus the wire W connected to the wire connection portion 17 also rotates in the clockwise direction around the fastening portion 12. Then, the wire W attempts to move down relative to the wire fixing portion 25.

As shown in FIG. 10, the lower movable region R2 is formed below the wire W indicated by the solid line. When the wire W attempts to move downward relative to the wire fixing portion 25, the wire W is allowed to move downward in the second direction toward the lower movable region R2. Therefore, even when the wire W comes into contact with the inner surface of the wire fixing portion 25 from above, the reaction force of the wire W is reduced and deformation of the terminal cover 20 is suppressed.

### Effects of Embodiment

(1) The terminal 10 with a cover is the terminal 10 with a cover, including: the terminal cover 20; the wire W; the terminal 11; and the cable tie 70, wherein the terminal 11 has the fastening portion 12 to be fastened to the stud bolt SB provided on a counterpart device, and the wire connection portion 17 connected to the wire W, the terminal cover 20 has the terminal accommodation portion 21 that accommodates the terminal 11, and the wire fixing portion 25 that is continuous with the terminal accommodation portion 21 and to which the wire W is fixed by the cable tie 70 and from which the wire W is drawn out, and the wire fixing portion 25 is configured to suppress movement of the wire W in the first direction in a view from a direction in which the wire W is drawn out and to allow the wire W to move in the second direction orthogonal to the first direction.

With such a configuration, the wire fixing portion 25 can inhibit the wire W from moving in the first direction while the wire fixing portion 25 allows the wire W to move in the second direction. Therefore, when the wire W attempts to be displaced in the second direction, by allowing room for the wire W to the movable regions R1 and R2, it is possible to inhibit the terminal cover 20 from deforming due to the reaction force of the wire W.

(2) The second direction is a direction in which the wire W can move when the fastening portion 12 is fastened to the stud bolt SB.

With such a configuration, when the wire W moves in the second direction by fastening the fastening portion 12 to the stud bolt SB, it is possible to allow room for the wire W to the movable regions R1 and R2.

(3) The second direction is a direction in which the wire W can rotate around the fastening portion 12 in a view from the first direction.

With such a configuration, when the wire W rotates in the second direction around the fastening portion 12 in a view from the first direction, it is possible to allow room for the wire W to the movable regions R1 and R2.

(4) The wire fixing portion 25 has a band insertion hole 29 into which the cable tie 70 is inserted, the cable tie 70 has an insertion portion 71A inserted into the band insertion hole 29, and the wire contact portion 71B that is in contact with the wire W, and the first direction is a direction from the wire contact portion 71B toward the insertion portion 71A.

With such a configuration, when the wire W is fixed to the wire fixing portion 25 by using the cable tie 70, the wire W can be fixed in the first direction between the wire contact portion 71B and the insertion portion 71A of the cable tie 70.

(5) The terminal 11 has the connector 14 that connects the fastening portion 12 and the wire connection portion 17, and the connector 14 positions the wire connection portion 17 at a predetermined angle with respect to the fastening portion 12.

With such a configuration, for example, even when the position of the fastening portion 12 varies when the connector 14 is subjected to bending processing, the wire W can move in the second direction, thereby suppressing deformation of the terminal cover 20 caused by the reaction force of the wire W.

(6) The wire connection portion 17 has the wire barrel 15 to which the core wire of the wire W is crimped.

With such a configuration, for example, even when the position of the fastening portion 12 varies when the wire barrel 15 is crimped, the wire W can move in the second direction, thereby suppressing the deformation of the terminal cover 20.

### Other Embodiments

This embodiment can be modified and implemented as follows. This embodiment and the following modification examples may be combined and implemented to the extent that they do not contradict each other technically.
Although the cable tie 70 is described as an example of a binding member in the above embodiment, a binding method using tape rolling may be used, and in such a case, the binding member is a piece of tape.
Although a configuration in which the wire W moves to the movable regions R1 and R2 due to the fastening portion 12 being bent up or bent down is described as an example in the above embodiment, a configuration may also be possible in which, when the fastening portion 12 is not bent up or bent down, the wire W does not move to the movable region R1 or R2.
Although bending of the connector 14 and the crimping of the wire barrel 15 are described as examples of causes of the bent-up or bent-down in the above embodiment, other causes may also be acceptable.
Although the terminal 11 has the connector 14 that connects the fastening portion 12 and the wire connection portion 17, and the connector 14 positions the wire connection portion 17 at a predetermined angle with respect to the fastening portion 12 in the above embodiment, the predetermined angle may also be approximately 180 degrees.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal with a cover, comprising:
a terminal cover;
a wire;
a terminal; and
a binding member,
wherein the terminal has a fastening portion to be fastened to a device-side connection portion provided on a counterpart device, and a wire connection portion connected to the wire,
the terminal cover has a terminal accommodation portion that accommodates the terminal, and a wire fixing portion that is continuous with the terminal accommodation portion and to which the wire is fixed by the binding member and from which the wire is drawn out, and
the wire fixing portion is configured to suppress movement of the wire in a first direction in a view from a direction in which the wire is drawn out and to allow the wire to move in a second direction orthogonal to the first direction.

2. The terminal with a cover according to claim 1,
wherein the second direction is a direction in which the wire can move when the fastening portion is fastened to the device-side connection portion.

3. The terminal with a cover according to claim 1,
wherein the second direction is a direction in which the wire can rotate around the fastening portion in a view from the first direction.

4. The terminal with a cover according to claim 1,
wherein the binding member is a cable tie, the wire fixing portion has a band insertion hole into which the cable tie is inserted,
the cable tie has an insertion portion inserted into the band insertion hole, and a wire contact portion that is in contact with the wire, and
the first direction is a direction from the wire contact portion toward the insertion portion.

5. The terminal with a cover according to claim 1,
wherein the terminal has a connector that connects the fastening portion and the wire connection portion, and the connector positions the wire connection portion at a predetermined angle with respect to the fastening portion.

6. The terminal with a cover according to claim 1,
wherein the wire connection portion has a wire barrel to which a core wire of the wire is crimped.
